(19) United States
(12) Patent Application Publication
(10) Pub. No.: US 2016/0146679 A1
(43) Pub. Date: May 26, 2016

(54) ARRANGEMENTS AND METHOD FOR MEASURING A FORCE OR A TORQUE ON A MACHINE ELEMENT

(71) Applicant: SCHAEFFLER TECHNOLOGIES AG & CO. KG, Herzogenaurach (DE)

(72) Inventor: Stephan Neuschaefer-Rube, Herzogenaurach (DE)

(73) Assignee: Schaeffler Technologies AG & Co. KG, Herzogenaurach (DE)

(21) Appl. No.: 14/898,235

(22) PCT Filed: May 13, 2014
(86) PCT No.: PCT/DE2014/200210

§ 371 Date: Dec. 14, 2015

(30) Foreign Application Priority Data
Jun. 13, 2013 (DE) 10 2013 211 000.6

(51) Int. Cl. G01L 1/12; G01L 3/10

(52) U.S. Cl. CPC G01L 1/122; G01L 1/125; G01L 3/102; G01L 3/104

(57) ABSTRACT

The present invention relates to arrangements for measuring a force and/or a torque on a machine element (01) extending in an axis (03) using the inverse magnetostrictive effect. The invention further relates to a method for measuring a force and/or a torque, wherein the force or the torque is acting on a machine element (01) extending along an axis (03). In a first arrangement according to the invention, the machine element (01) has a permanent magnetization (04) that is aligned with the axis (03). The arrangement further includes at least one magnetic field sensor (16, 17, 18, 19) that is designed to measure at least one vectorial component of a magnetic field generated by the permanent magnetization (04) and by the force and/or by the torque.

### BACKGROUND

The present invention relates to arrangements for measuring a force and/or a torque on a machine element extending along an axis by the use of the inverse-magnetostrictive effect. The invention also relates to a method for measuring a force and/or a torque, wherein the force or the torque acts on a machine element extending along an axis.

DE 698 38 904 T2 shows a torque sensor with circular magnetization in a magnetoelastic active area on a shaft exposed to a torque. The magnetic field in the vicinity of the magnetoelastic active area is measured with the help of a Hall effect sensor.

From DE 600 08 543 T2, a converter element is known that is provided for a use in a torque or force sensor. The converter element is provided integrally in a shaft made from magnetizable material and has a magnetization aligned in an axial direction.

DE 600 07 641 T2 shows a converter element that is provided for a torque or force sensor converter. In this converter element, magnetizations are formed in a radially inner region and in a radially outer region.

From DE 603 09 678 T2, a method for detecting a torque in a shaft is known in which magnetic fields with alternating polarity are generated that are measured with a sensor arrangement.

DE 601 05 794 T2 shows a force-sensitive converter element with a body made from magnetic material, wherein, in the body, at least two magnetized areas are formed that extend at an angle to the direction of the force transmission and have opposing magnetization polarities.

DE 699 36 138 T2 shows a magnetic force sensor in which a magnetized material is exposed to a bending moment, wherein the external magnetic field of the magnetized material can be determined with the help of a sensor arrangement.

WO 2011/085400 A1 shows a magnetoelastic force sensor with which mechanical loads of an element can be measured.

### SUMMARY

Starting with the prior art, the objective of the present invention lies in expanding the options for measuring forces and torques under the use of the inverse-magnetostrictive effect.

The mentioned objective is achieved by an arrangement and by methods including one or more features of the invention.

An arrangement for measuring a force and/or a torque on a machine element extending along an axis forms a first subject matter of the invention. The force or the torque acts on the machine element, generating mechanical stress and in most cases slightly deforming the machine element. The machine element has a permanent magnetization. The permanent magnetization is oriented along the axis, wherein the machine element and the permanent magnetization are arranged coaxial to each other. Opposite poles of the permanent magnetization can be connected by a straight line that is arranged parallel to the axis. The arrangement further comprises at least one magnetic field sensor that is arranged opposite the machine element. The magnetic field sensor is used for determining a magnetic field and is formed for measuring at least one vectorial component of a magnetic field that emerges out of the machine element and is produced on one hand by the permanent magnetization and on the other hand by the force and/or the torque. In a first category of preferred embodiments, this vectorial component is not the component oriented along the axis or parallel to the axis of the machine element and the permanent magnetization in the magnetic field produced by the permanent magnetization and by the force and/or by the torque. With the help of the magnetic field sensor it is possible to measure the magnetic field that occurs due to the inverse magnetostrictive effect due to the permanent magnetization and consequently the force acting on the machine element or the torque acting on the machine element. Forces and/or torques can be measured in certain directions as a function of the vectorial component measured by the magnetic field sensor in the magnetic field produced by the permanent magnetization and by the force and/or by the torque and as a function of the arrangement of the magnetic field sensor opposite the machine element.

In the simplest case, the magnetic poles of the permanent magnetization are directly along the axis. In the simplest case there are also only two magnet poles, namely a north pole and a south pole of the permanent magnetization. Preferably, the permanent magnetization is formed in circumferential sections. These sections are formed along a circumference around the axis. Preferably, the polarity of the permanent magnetization changes between the sections, so that along a circumference around the axis, north poles and south poles of the permanent magnetization alternate with each other. The permanent magnetization in individual circumferential sections can be viewed as individual magnetization, wherein also all of the individual magnetizations are each oriented along the axis. On the circumference around the axis, between the circumferential sections of the permanent magnetization there can also be non-magnetized circumferential sections. The circumferentially alternating permanent magnetization enables an exact measurement of the magnetic field changes that are produced by forces and/or torques on the machine element due to the magnetostrictive effect.

The circumferential sections of the permanent magnetization preferably have the same central angle relative to the axis. The circumferential sections of the permanent magnetization also have an equal axial length and are arranged flush relative to each other along the axis. Thus, the circumferential sections of the permanent magnetization preferably have the same size. Furthermore, the circumferential sections of the permanent magnetization are preferably distributed equally along the circumference around the axis.

Preferably two to ten of the circumferential sections of the permanent magnetization are formed. In an especially preferred way, four of the circumferential sections of the permanent magnetization are formed.

In preferred embodiments of the arrangement according to the first subject matter of the invention, the permanent magnetization is oriented only along the axis. Consequently, the permanent magnetization has no directional component that is not in the axis or parallel to the axis. Thus it is excluded that the permanent magnetization is arranged, for example, at an angle relative to the axis.

In a first group of preferred embodiments of the arrangement according to the first subject matter of the invention, the one magnetic field sensor or the multiple magnetic field sensors are formed for measuring the component oriented in the tangential direction relative to the axis in the magnetic field produced by the permanent magnetization and by the force and/or by the torque. Consequently, the one magnetic field sensor or multiple magnetic field sensors measures or measure the component that extends circumferentially around the axis in the magnetic field produced by the permanent magnetization and by the force and/or by the torque. In this case, no other components of this magnetic field can be measured by the magnetic field sensor or sensors.

The machine element can be preferably loaded and possibly also deformed by a torque oriented along the axis, wherein the component oriented in the tangential direction relative to the axis in the magnetic field produced by the permanent magnetization and by the torque is a measure of the mechanical stress produced by the torque. Consequently, with the magnetic field sensor or sensors for measuring the component oriented in the tangential direction relative to the axis in the magnetic field produced by the permanent magnetization and by the torque, it is possible to measure the torque. The torque oriented along the axis has a rotational axis that coincides with the axis of the machine element or is at least parallel to it. This torque leads, in particular, to a torsion of the machine element. The machine element preferably can be elastically deformed by the torque oriented along the axis.

In the mentioned first group of preferred embodiments of the arrangement according to the first subject matter of the invention, preferably four of the magnetic field sensors are provided that are arranged distributed uniformly around the axis at an equal distance from the axis. Consequently, the four magnetic field sensors have, in pairs, a central angle of 90° with respect to the axis relative to each other. Here, the magnetic field sensors are preferably in a common plane that is oriented perpendicular to the axis. In the same way, four of the circumferential sections of the permanent magnetization are formed that are distributed uniformly about the axis. Consequently, the four circumferential sections of the permanent magnetization and the four magnetic field sensors are opposite each other. Here, two opposing sensors of the four magnetic field sensors are preferably connected so that the signals add together, wherein the influence of other torques and forces, especially transverse forces on the machine element and the resulting magnetic field is eliminated in the measurement by the magnetic field sensors. In this way, the measurement is limited to the torque oriented along the axis.

In embodiments of the first group of preferred embodiments of the arrangement according to the first subject matter of the invention, the machine element alternatively can be loaded and possibly deformed by a transverse force oriented perpendicular to the axis, wherein the component oriented in the tangential direction relative to the axis in the magnetic field produced by the permanent magnetization and by the transverse force is a measure of the mechanical stress produced by the transverse force. Consequently, with the magnetic field sensor or with the magnetic field sensors, by determining the component of the magnetic field oriented in the tangential direction relative to the axis, the transverse force acting on the machine element can be measured. Preferably, the machine element can be deformed elastically by the transverse force oriented perpendicular to the axis. The transverse force can lead, for example, to a bending of the machine element.

For measuring the transverse force, preferably two of the magnetic field sensors are provided that are distributed equally about the axis at an equal distance from the axis. Consequently, the two magnetic field sensors have a central angle of 180° with respect to the axis relative to each other and are arranged opposite each other with respect to the axis. They are located preferably in a common plane that is arranged perpendicular to the axis. The two magnetic field sensors are preferably connected to each other so that their signals are subtracted. Here, preferably four of the circumferential sections of the permanent magnetization are formed that are arranged equally about the axis.

In a second group of preferred embodiments of the arrangement according to the first subject matter of the invention, the one magnetic field sensor or the multiple magnetic field sensors are formed for measuring the component oriented in a radial direction relative to the axis in the magnetic field produced by the permanent magnetization and by the force and/or by the torque. The component of the magnetic field oriented in the radial direction relative to the axis is arranged perpendicular to the axis and intersects the axis. Preferably, the magnetic field sensor or sensors are formed for measuring only the component oriented in the radial direction relative to the axis in the magnetic field produced by the permanent magnetization and by the force and/or by the torque.

In the second group of preferred embodiments of the arrangement according to the first subject matter of the invention, the machine element can be preferably loaded and possibly deformed by a torque oriented along the axis, wherein the component oriented in the radial direction relative to the axis in the magnetic field produced by the permanent magnetization and by the torque is a measure of the mechanical stress produced by the torque. Consequently, with the magnetic field sensor or with the magnetic field sensors, the torque acting on the machine element can be measured. Preferably the machine element can be elastically deformed by the torque oriented along the axis.

In a third group of preferred embodiments of the arrangement according to the first subject matter of the invention, the one magnetic field sensor or the multiple magnetic field sensors are formed for measuring the component oriented along the axis or parallel to the axis in the magnetic field produced by the permanent magnetization and by the force and/or by the torque. Preferably, the magnetic field sensor or sensors are formed for measuring only the component oriented in the axial direction relative to the axis in the magnetic field produced by the permanent magnetization and by the force and/or by the torque.

In the third group of preferred embodiment of the arrangement according to the first subject matter of the invention, the machine element can be preferably loaded and possibly deformed by a tensile force oriented along the axis or by a compressive force oriented along the axis, wherein the component oriented in the axial direction in the magnetic field produced by the permanent magnetization and by the torque is a measure of the mechanical stress produced by the tensile force or the compressive force. Consequently, with the magnetic field sensor or with the magnetic field sensors, the tensile force or compressive force acting on the machine element can be measured. Preferably, the machine element can be elastically deformed by the tensile force or compressive force oriented along the axis.

A second subject matter of the present invention forms another arrangement for measuring a force and/or a torque on a machine element extending along an axis. The machine element has a permanent magnetization that is oriented in the radial direction relative to the axis. Consequently, the poles of the magnetization, namely one or more pairs each of a north pole and a south pole each lie on a radius that runs perpendicular to the axis and starting from the axis. The arrangement further comprises at least one magnetic field sensor that is formed for measuring at least one vectorial component of a magnetic field coming from the machine element and produced by the permanent magnetization and by the force and/or by the torque. This vectorial component of the magnetic field produced by the permanent magnetization and by the force and/or by the torque is preferably not oriented in the radial direction relative to the axis. With the help of the magnetic field sensor, it is possible to measure the magnetic field that occurs due to the inverse magnetostrictive effect due to the permanent magnetization and due to the force acting on the machine element or due to the torque acting on the machine element.

The permanent magnetization can comprise multiple components that are each oriented in the radial direction relative to the axis. Preferably, the permanent magnetization is only oriented in the radial direction relative to the axis. Consequently, the permanent magnetization has preferably no other directional component, for example, in the direction of the axis or tangential to the axis. Therefore, the permanent magnetization is preferably oriented not at an angle to a radius. In so far as the permanent magnetization comprises multiple components, the components are also oriented preferably each only in the radial direction relative to the axis.

In preferred embodiments of the arrangement according to the invention according to the second subject matter of the invention, the permanent magnetization is formed in axial sections between which the polarity of the permanent magnetization changes. Within the axial sections, the permanent magnetization can be formed completely all-around or in circumferential sections. Within the axial sections, the polarity of the permanent magnetization preferably does not change. Non-magnetized axial sections can be located between the axial sections of the permanent magnetization.

The axial sections of the permanent magnetization preferably have an equal axial length. Preferably two to ten of the axial sections are formed. In an especially preferred way, three of the axial sections of the permanent magnetization are formed.

The arrangement according to the second subject matter of the invention preferably comprises two of the magnetic field sensors that are distributed equally about the axis at an equal distance from the axis. Consequently, the two magnetic field sensors have a central angle of 180° relative to each other with respect to the axis and are arranged opposite each other with respect to the axis. Preferably, the two magnetic field sensors are arranged in a common plane that is oriented perpendicular to the axis.

In a first group of preferred embodiments of the arrangement according to the invention according to the second subject matter of the invention, the one magnetic field sensor or the multiple magnetic field sensors are formed for measuring at least one component oriented in the tangential direction relative to the axis in the magnetic field produced by the permanent magnetization and by the force and/or by the torque. This is a component that at least partially surrounds the axis circumferentially. In an especially preferred way, the magnetic field sensor or sensors are formed for measuring only the component oriented in the tangential direction relative to the axis in the magnetic field produced by the permanent magnetization and by the force and/or by the torque. Consequently, with the magnetic field sensors, only one component of the magnetic field can be detected that is produced due to the inverse magnetostrictive effect for mechanical loading of the machine element.

In the first group of preferred embodiments of the arrangement according to the second subject matter of the invention, the machine element can be preferably loaded and possibly deformed by a torque oriented perpendicular to the axis, wherein the component oriented in the tangential direction relative to the axis in the magnetic field produced by the permanent magnetization and by the torque is a measure of the mechanical stress produced by the torque. The torque oriented perpendicular to the axis is, in particular, a bending moment that leads to bending of the machine element. The machine element can be preferably elastically deformed by the transverse moment oriented perpendicular to the axis. The torque oriented perpendicular to the axis has a rotational axis that preferably intersects the axis.

In a second group of preferred embodiments of the arrangement according to the invention according to the second subject matter of the invention, the magnetic field sensor or the magnetic field sensors are formed for measuring at least one component oriented along the axis in the magnetic field produced by the permanent magnetization and by the force and/or by the moment. Here, the magnetic field sensor or sensors are formed in an especially preferred way for measuring only the component oriented along the axis in the magnetic field produced by the permanent magnetization and by the force and/or by the torque.

In the second group of preferred embodiments of the arrangement according to the second subject matter of the invention, the machine element can be preferably loaded and possibly deformed by a transverse force oriented perpendicular to the axis, wherein the component oriented along the axis in the magnetic field produced by the permanent magnetization and by the transverse force is a measure of the mechanical stress produced by the transverse force. The transverse force leads, in particular, to a bending of the machine element. The machine element can be preferably elastically deformed by the transverse force oriented perpendicular to the axis.

The following description of preferred embodiments relates to arrangements according to the invention according to the first subject matter of the invention and according to the second subject matter of the invention.

The permanent magnetization is preferably formed in an axial magnetization section of the machine element. This axial magnetization section can comprise the axial sections of magnetization of alternating polarity. In each case, the machine element can extend far beyond the permanent magnetization along the axis. In so far as, for example, a torque arranged in the axis is to be measured, a short axial magnetization section is sufficient to be able to determine the resulting magnetic field.

The component with the permanent magnetization is connected at least rigidly to the machine element or to a main component of the machine element, wherein the permanent magnetization is exposed together with the machine element to the mechanical stress occurring on the machine element. The permanent magnetization is preferably formed integrally with the machine element or with a main component of the machine element. In each case, however, these are not additional permanent magnets that are attached, for example, on the outside to the machine element and not exposed to the mechanical stresses occurring on the machine element. The permanent magnetization is preferably formed in a magnetoelastic section of the machine element. In the magnetoelastic section of the machine element, the machine element preferably consists of a magnetostrictive material. Preferably, not only a section, but instead the machine element is formed as such with magnetoelastic properties. In this case, the machine element is made from a magnetostrictive material.

The magnetic field sensor or sensors are preferably arranged stationary and at a distance to the machine element. While the force or the torque can lead to movements or deformation of the machine element, the magnetic field sensors do not change their stationary position.

The machine element preferably has the shape of a prism or a cylinder, wherein the prism or the cylinder is arranged coaxial to the axis. The prism or the cylinder is preferably straight. In an especially preferred way, the machine element has the shape of a straight circular cylinder, wherein the circular cylinder is arranged coaxial to the axis. In so far as the machine element has circumferential sections of the permanent magnetization, these circumferential sections are formed by cylindrical arc sections. For special embodiments, the prism or the cylinder has a conical shape, in particular, in the third group of preferred embodiments of the arrangement according to the first subject matter of the invention.

The machine element is preferably formed by a shaft or by a flange. The shaft or the flange can be designed for loads due to different forces and torques.

The machine element preferably has a hollow space through which the axis runs at least in some sections. Consequently, the hollow space encloses at least one section of the axis. The hollow space preferably extends along the axis.

The hollow space preferably has a cylindrical shape, wherein the cylindrical shape is arranged coaxial to the axis.

The one magnetic field sensor or multiple magnetic field sensors are preferably arranged in the hollow space. The one magnetic field sensor or multiple magnetic field sensors are alternatively arranged preferably outside of the hollow space.

The one magnetic field sensor or multiple magnetic field sensors are preferably formed by Hall-effect sensors, coils, or flux-gate magnetometers. In principle, other sensors types could also be used, in so far as they are suitable for measuring the magnetic fields caused by the inverse magnetostrictive effect.

A method for measuring a force and/or a torque forms a third subject matter of the invention. The force or the torque acts on a machine element extending along an axis. The machine element has a permanent magnetization that is oriented along the axis. Consequently, the permanent magnetization has one or more pairs of magnetic poles, namely a north pole and a south pole, whose connecting line is arranged along the axis or parallel to the axis. The force or the torque is determined by measuring at least one vectorial component of a magnetic field emerging from the machine element and caused by the permanent magnetization and also by the force and/or by the torque due to the inverse magnetostrictive effect. Preferably, this vectorial component of the magnetic field is not oriented along the axis. Preferably, the vectorial component of the magnetic field caused by the permanent magnetization and also by the force and/or by the torque is oriented in the tangential direction relative to the axis or in the radial direction relative to the axis.

The method according to the method according to the third subject matter of the invention corresponds to the arrangement according to the first subject matter of the invention. Consequently, the method according to the third subject matter of the invention is preferably applied to arrangements that are described according to the first subject matter of the invention and its preferred embodiments.

A method for measuring a force and/or a torque forms a fourth subject matter. The force or the torque acts on a machine element extending along an axis. The machine element has a permanent magnetization that is oriented in the radial direction relative to the axis. Consequently, the permanent magnetization has one or more pairs of magnetic poles, namely a north pole and a south pole, whose connecting lines each form a radius that intersects the axis. The force or the torque is therefore determined by measuring at least one vectorial component of a magnetic field emerging from the machine element and produced by the permanent magnetization and also by the force and/or by the torque due to the inverse magnetostrictive effect. This vectorial component is preferably not oriented in the radial direction relative to the axis. Preferably, this component of the magnetic field produced by the permanent magnetization and also by the force and/or by the torque is oriented in the tangential direction relative to the axis or along the axis.

The method according to the fourth subject matter of the invention corresponds to the arrangement according to the second subject matter of the invention. Consequently, the method according to the fourth subject matter of the invention is preferably applied to arrangements that are formed according to the second subject matter of the invention and its preferred embodiments.

### BRIEF DESCRIPTION OF THE DRAWINGS

Additional advantages, details, and refinements of the invention are given from the following description of preferred embodiments with reference to the drawing. Shown are:

FIG. 1: an arrangement according to the invention with permanent magnetization oriented in the axial direction for measuring a torque,

FIG. 2: an arrangement according to the invention with permanent magnetization oriented in the axial direction for measuring a transverse force,

FIG. 3: another arrangement according to the invention with magnetization oriented in the axial direction for measuring a torque,

FIG. 4: an arrangement according to the invention with magnetization oriented in the radial direction for measuring a bending moment, and

FIG. 5: an arrangement according to the invention with permanent magnetization oriented in the radial direction for measuring a transverse force.

### DETAILED DESCRIPTION OF THE PREFERRED EMBODIMENTS

All of the figures show the arrangements according to the invention in two views. The upper parts of the figures each comprise a top view, while the lower parts of the figures each comprise a cross-sectional view of the respective arrangement according to the invention.

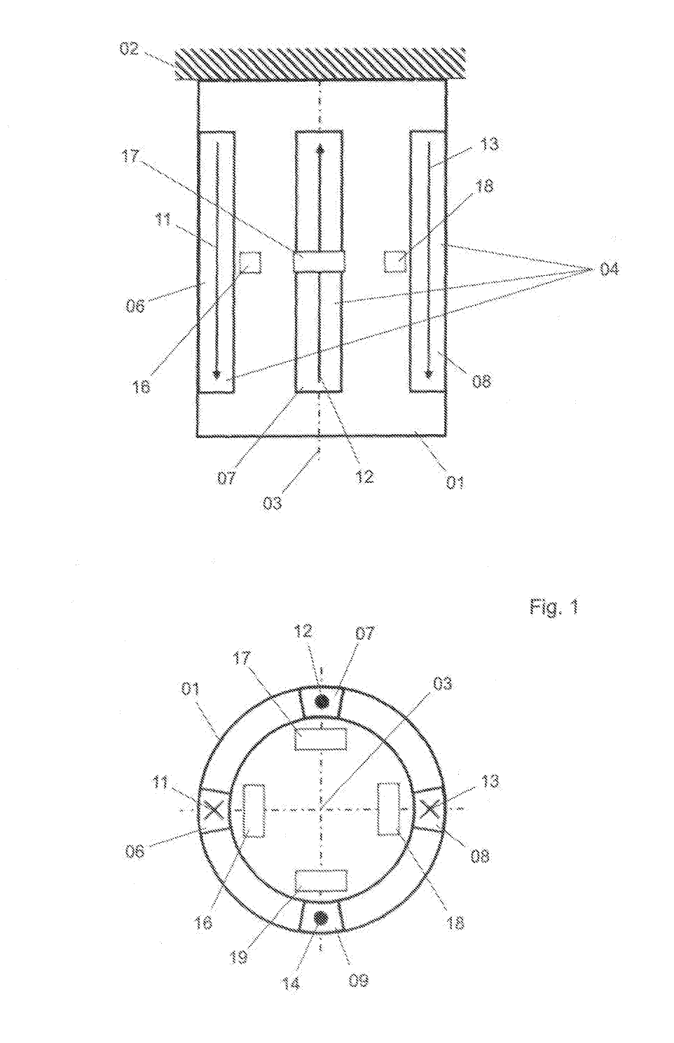

FIG. 1 shows a first preferred embodiment of an arrangement according to the invention. The arrangement initially comprises a machine element in the form of a flange 01 that is mounted on a base body 02. The flange 01 has the shape of a hollow circular cylinder. The flange 01 extends along an axis 03 that also forms the middle axis of the hollow cylindrical shape of the flange 01. The flange 01 is formed of a magnetoelastic material that has the magnetostrictive effect.

In an axial section of the flange 01, a permanent magnetization 04 is formed that extends in the same direction as the axis 03. The permanent magnetization 04 is not formed completely around the flange 01, but instead only in circumferential sections 06, 07, 08, 09, wherein the polarity of the permanent magnetization 04 changes between each of the circumferential sections 06, 07, 08, 09. The alternating polarity of the permanent magnetization 04 is symbolized by arrows 11, 12, 13, 14.

In the hollow space of the hollow cylindrical flange 01 there are four magnetic field sensors 16, 17, 18, 19 that have an equal distance to the axis 03 and are arranged distributed equally about this axis. Consequently, each of the four magnetic field sensors 16, 17, 18, 19 are placed opposite one of the four circumferential sections 06, 07, 08, 09 of the permanent magnetization 04. The four magnetic field sensors 16, 17, 18, 19 are each formed, for example, by a measurement coil. The four magnetic field sensors 16, 17, 18, 19 are formed to measure a magnetic field whose direction is arranged tangential to the axis 03. Consequently, with the four magnetic field sensors 16, 17, 18, 19, a magnetic field that is formed circumferentially about the axis 03 can be measured. The permanent magnetization 04 causes a magnetic field oriented tangential relative to the axis 03 if a mechanical loading of the flange 01 has resulted in the inverse magnetostrictive effect. This mechanical load is, in particular, a torque about the axis 03 that apples a torsion to the flange 01. Consequently, a torque acting on the flange 01 about the axis 03 can be measured with the four magnetic field sensors 16, 17, 18, 19.

The respectively opposite sensors of the four magnetic field sensors 16, 18; 17, 19 are connected so that their signals add, so that the effect of transverse forces on the flange 01 is eliminated and only the torque about the axis 03 is measured.

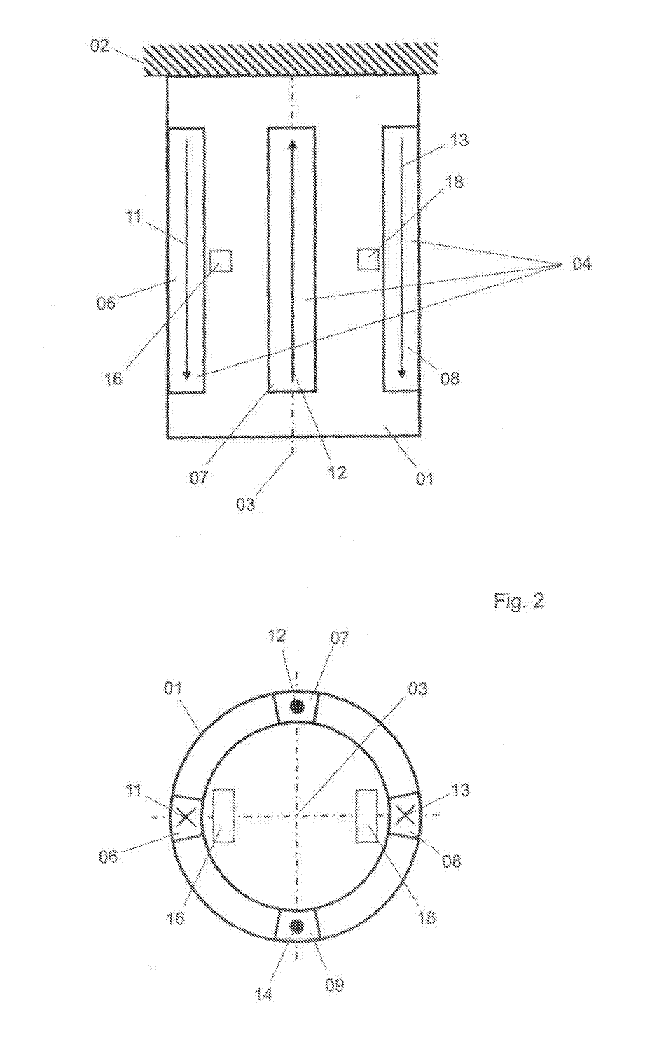

FIG. 2 shows another preferred embodiment of the arrangement according to the invention with permanent magnetization 04 oriented in the axial direction. This embodiment is formed for measuring a transverse force.

This embodiment of the arrangement according to the invention comprises, in turn, the flange 01 that is shown in FIG. 1 and is formed in the same way.

In contrast to the embodiment shown in FIG. 1, the embodiment shown in FIG. 2 comprises only two of the shown magnetic field sensors 16, 18 that are formed and arranged, however, in the same way as the magnetic field sensors 16, 18 shown in FIG. 1.

The two magnetic field sensors 16, 18 enable the measurement of a transverse force that acts on the flange 01 and is oriented perpendicular to the axis 03 and also according to the arrangement of the two magnetic field sensors 16, 18. If additional transverse forces can be measured, this embodiment can also be equipped with four of the magnetic field sensors that are arranged distributed equally about the axis 03.

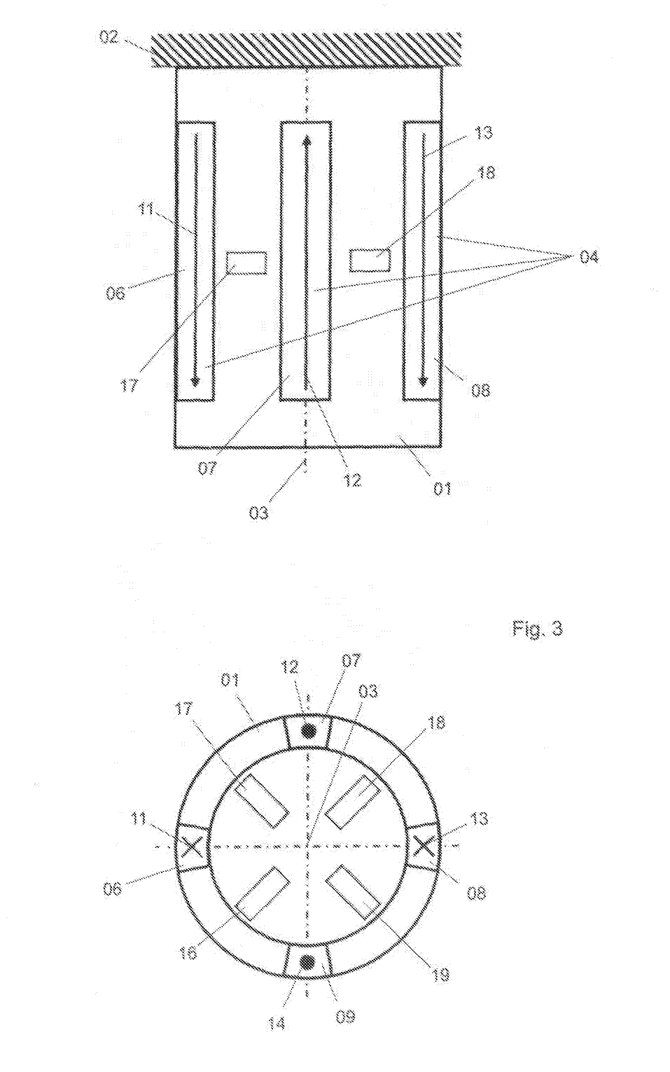

FIG. 3 shows another preferred embodiment of the arrangement according to the invention with a permanent magnetization 04 that is oriented in the axial direction. The embodiment shown in FIG. 3 is provided for measuring a torque and initially comprises, in turn, the flange 01 that is equal to the flange 01 shown in FIG. 1. Also, the embodiment shown in FIG. 3 comprises, in turn, the four magnetic field sensors 16, 17, 18, 19 that are formed, however, in contrast to the embodiment shown in FIG. 1, for measuring a magnetic field that extends in the radial direction relative to the axis 03. Also the four magnetic field sensors 16, 17, 18, 19 are arranged with an offset of 45° about the axis 03 relative to the four circumferential sections 06, 07, 08, 09 of the permanent magnetization 04. With the help of the four magnetic field sensors 16, 17, 18, 19, just like in the embodiment shown in FIG. 1, a torque about the axis 03 can be measured, wherein this torque acts on the flange 01 and applies a torsion to it.

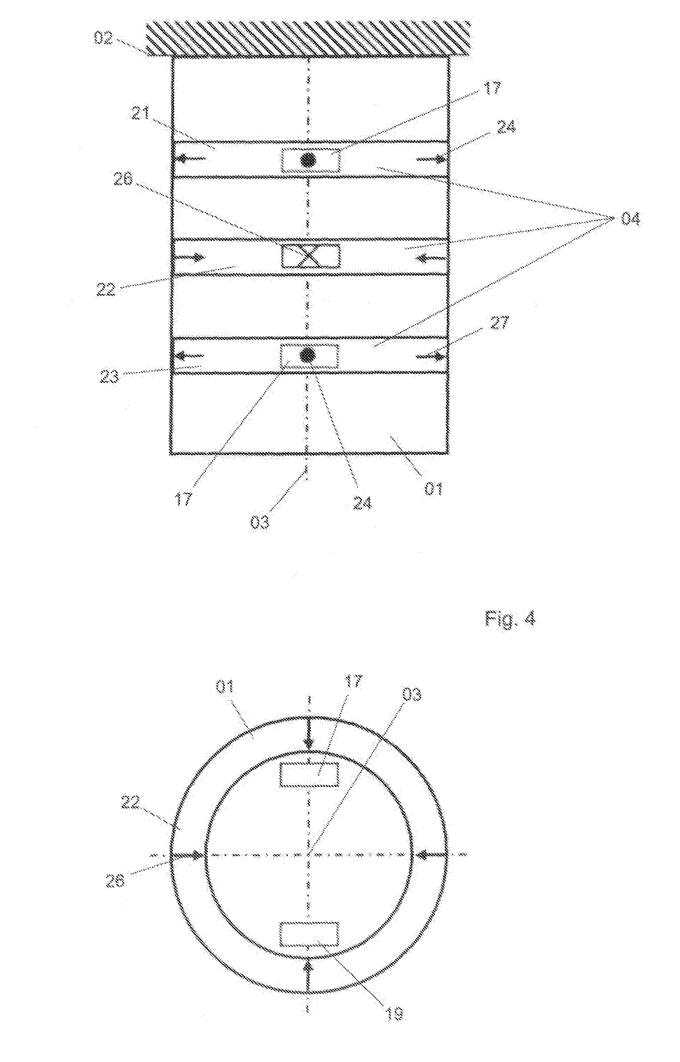

FIG. 4 shows another embodiment of the arrangement according to the invention. This embodiment has, in turn, the flange 01 that is initially equal to the flange 01 shown in FIG. 1, but differs in the construction of the permanent magnetization 04 from the flange 01 shown in FIG. 1. The permanent magnetization 04 is oriented in the radial direction, so that this points toward the axis 03 or away from the axis 03. The permanent magnetization 04 comprises three axial sections 21, 22, 23 between which the polarity of the permanent magnetization 04 changes. The polarity of the permanent magnetization 04 in the axial sections 21, 22, 23 is symbolized, in turn, by arrows 24, 26, 27.

In the hollow space of the hollow cylindrical flange 01 there are two of the magnetic field sensors 17, 19 that are equal to the magnetic field sensors 17, 19 shown in FIG. 1. With the help of the two magnetic field sensors 17, 19, a bending moment can be measured that acts on the flange 01 and whose rotational axis intersects the axis 03 at a right angle.

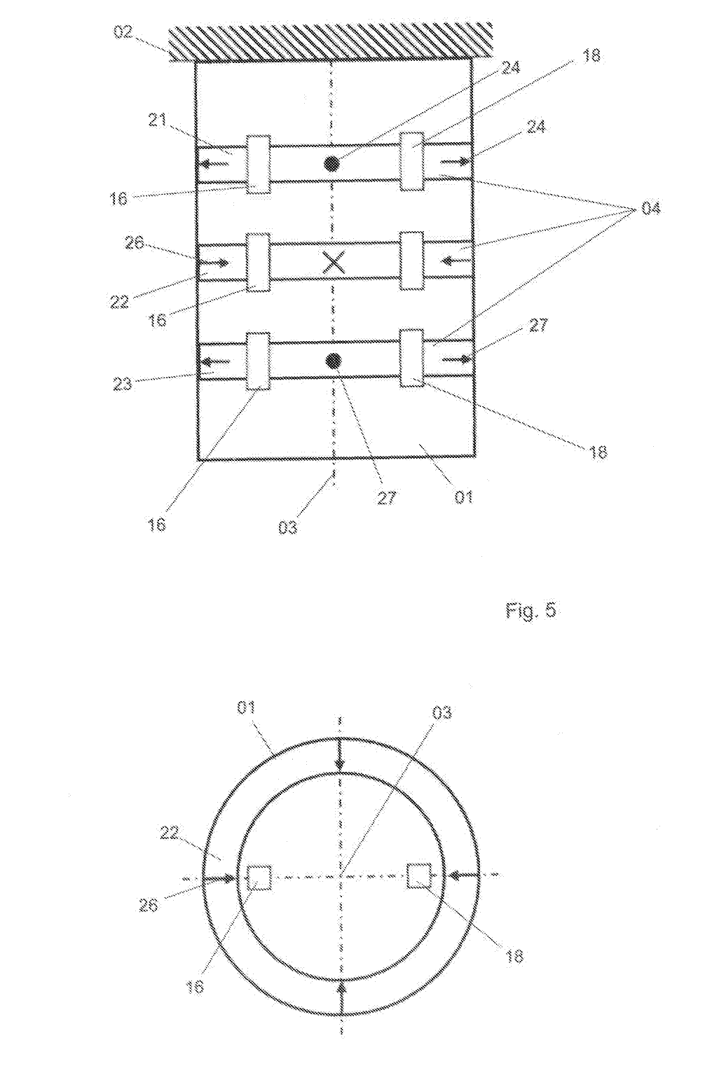

FIG. 5 shows another preferred embodiment of the arrangement according to the invention that has a permanent magnetization 04 oriented in the radial direction like the embodiment shown in FIG. 4. This embodiment comprises, in turn, the flange 01 that is equal to the flange 01 shown in FIG. 4 including the permanent magnetization 04.

In the hollow space of the hollow cylindrical flange 01 there are two of the magnetic field sensors 16, 18 whose arrangement is initially equal to the arrangement of the magnetic field sensors 16, 18 shown in FIG. 1. In contrast to the magnetic field sensors shown in FIG. 1, the magnetic field sensors 16, 18 shown in FIG. 5 are formed for measuring a magnetic field that extends in the direction of the axis 03. Such a magnetic field is produced due to the inverse magnetostrictive effect when a transverse force acts on the flange 01 at a right angle to the axis 03.

### LIST OF REFERENCE NUMBERS

01 Flange
02 Base body
03 Axis
04 Permanent magnetization
05
06 Circumferential section of the permanent magnetization
07 Circumferential section of the permanent magnetization
08 Circumferential section of the permanent magnetization
09 Circumferential section of the permanent magnetization
10
11 Arrow
12 Arrow
13 Arrow
14 Arrow
15
16 Magnetic field sensor
17 Magnetic field sensor
18 Magnetic field sensor
19 Magnetic field sensor
20
21 Axial section of the permanent magnetization
22 Axial section of the permanent magnetization
23 Axial section of the permanent magnetization
24 Arrow
25
26 Arrow
27 Arrow

1. An arrangement for measuring at least one of a force or a torque on a machine element extending along an axis, comprising a machine element that has a permanent magnetization that is oriented along the axis, and at least one magnetic field sensor that is formed for measuring at least one component of a magnetic field caused by the permanent magnetization and by the at least one of the force or the torque.

2. The arrangement according to claim 1, wherein the permanent magnetization is formed in circumferential sections between which a polarity of the permanent magnetization changes.

3. The arrangement according to claim 2, wherein the one magnetic field sensor or the multiple magnetic field sensors are formed for measuring the component oriented in a tangential direction relative to the axis in the magnetic field caused by the permanent magnetization and by the at least one of force or the torque.

4. The arrangement according to claim 2, wherein the one magnetic field sensor or the multiple magnetic field sensors are formed for measuring the component oriented in a radial direction relative to the axis in the magnetic field caused by the permanent magnetization and by the at least one of force or the torque.

5. An arrangement for measuring at least one of a force or a torque on a machine element extending along an axis, comprising a machine element that has a permanent magnetization that is oriented in a radial direction relative to the axis, and at least one magnetic field sensor that is formed for measuring at least one component of a magnetic field produced by the permanent magnetization and by the at least one of the force or the torque.

6. The arrangement according to claim 5, wherein the permanent magnetization is formed in axial sections between which a polarity of the permanent magnetization changes.

7. The arrangement according to claim 5, wherein the one magnetic field sensor or the multiple magnetic field sensors are formed for measuring at least one component oriented in a tangential direction relative to the axis in the magnetic field produced by the permanent magnetization and by the at least one of the force or the torque.

8. The arrangement according to claim 5, wherein the one magnetic field sensor or the multiple magnetic field sensors are formed for measuring at least one component oriented along the axis in the magnetic field produced by the permanent magnetization and by the at least one of the force or the torque.

9. A method for measuring at least one of a force or a torque, comprising applying the at least one of the force or the torque on a machine element that extends along an axis and has a permanent magnetization that is oriented along the axis, and determining the at least one of force or the torque by measuring at least one component of a magnetic field produced by the permanent magnetization and by the at least one of the force or the torque.

10. A method for measuring at least one of a force or a torque, comprising applying the at least one of force or the torque on a machine element that extends along an axis and has a permanent magnetization that is oriented in a radial direction relative to the axis, and determining the at least one of the force or the torque by measuring at least one component of a magnetic field produced by the permanent magnetization and by the at least one of force or the torque.
